(19) United States
(12) Patent Application Publication
(10) Pub. No.: US 2017/0299788 A1
(43) Pub. Date: Oct. 19, 2017

(54) CURVED DIFFRACTION GRATING, SPECTROMETER AND MANUFACTURING METHOD OF CURVED DIFFRACTION GRATING

(71) Applicant: ACADEMIA SINICA, Taipei (TW)

(72) Inventors: Pei-Kuen WEI, Taipei City (TW); En-Hung LIN, New Taipei City (TW); Shu-Cheng LO, Hsinchu City (TW); Kuang-Li LEE, Keelung City (TW)

(21) Appl. No.: 15/488,050

(22) Filed: Apr. 14, 2017

Related U.S. Application Data
(60) Provisional application No. 62/323,443, filed on Apr. 15, 2016.

(51) Int. Cl. G02B 5/18; G01J 3/02; G01J 3/18

(52) U.S. Cl. CPC G02B 5/1861; G02B 5/1852; G01J 3/1809; G01J 3/0208; G01J 3/021; G01J 3/0221

(57) ABSTRACT

A curved diffraction grating includes a substrate and a metal layer. The substrate is a two-dimensional curved plate structure and has a first surface, a second surface and a plurality of microstructures. The first surface is disposed opposite to the second surface, and the microstructures are disposed on the second surface. Each of the microstructures is a saw-tooth structure and has a clear blazed angle. The metal layer is disposed on the microstructures and has a plurality of diffraction structures corresponding to the microstructures. A spectrometer containing the curved diffraction grating and a manufacturing method of the curved diffraction grating are also disclosed.

### CROSS REFERENCE TO RELATED APPLICATIONS

The non-provisional patent application claims priority to U.S. provisional patent application with Ser. No. 62/323,443 filed on Apr. 15, 2016. This and all other extrinsic materials discussed herein are incorporated by reference in their entirety.

### BACKGROUND OF THE INVENTION

### Field of Invention

The present disclosure relates to a manufacturing method of a curved diffraction grating and, in particular, to a curved diffraction grating, a spectrometer, and a manufacturing method of a curved diffraction grating.

### Related Art

The spectrometer is an instrument for decomposing a complex optical signal into spectrum lines, and it plays an important role in wide applications such as environmental monitoring, medical diagnostics, and space or geologic discoveries. As shown in FIG. 1, a conventional spectrometer includes an incident unit 42, two concave mirrors 441 and 442 for collimating and focusing light beams, a planar diffraction grating element 41, and a detection array 43. In practice, the blazed grating structure is commonly used in the diffraction element of the spectrometer because of its high grating efficiency at the +1^{st} order direction. Owing to the requirement of optical alignments and mountings, the spectrometer is bulky. Therefore, it is desired to provide a diffraction grating with the functions of light collimation, focusing and high diffraction, thereby sufficiently minimizing the size of the spectrometer.

### SUMMARY OF THE INVENTION

In view of the foregoing, an objective of the disclosure is to provide a curved diffraction grating, a spectrometer, and a manufacturing method of a curved diffraction grating. Herein, the curved diffraction grating is a two-dimensional curved plate structure. The curved substrate of the curved diffraction grating has a plurality of saw-tooth microstructures, so that the grating can have high spectral dispersion efficiency and the collimation and focusing functions as a concave mirror. Besides, the manufacturing process of the curved diffraction grating is easy. The disclosure can provide a high spectral resolution and sufficiently minimize the volume and weight of the system.

To achieve the above objective, the present disclosure discloses a curved diffraction grating, which includes a substrate and a metal layer. The substrate is a two-dimensional curved plate structure and has a first surface, a second surface and a plurality of microstructures. The first surface is disposed opposite to the second surface, and the microstructures are disposed on the second surface. Each of the microstructures is a saw-tooth structure and has a first groove surface and a second groove surface. The metal layer is disposed on the microstructures and has a plurality of diffraction structures corresponding to the microstructures. An included angle (θ_{b} of FIG. 2C) between a normal line of the second surface and a normal line of the second groove surface of the microstructures is substantially equal to a blazed angle of the curved diffraction grating. The blazed angle is an important parameter of the diffraction grating that can collimate the radiation energy from the zero-order spectrum to the desired wavelength range. When the incident angle, the diffraction light and the blazed angle are equivalent, the diffraction light at the groove surface can have the strongest intensity.

In one embodiment, the diffraction structures have substantially blazed angles.

In one embodiment, the diffraction structures are configured on the two-dimensional curved plate structure.

In one embodiment, the diffraction wavelength of the diffraction structure is between 300 nm and 2000 nm.

In one embodiment, the groove density of the diffraction structures is 200˜20000 lines/cm.

In one embodiment, the substrate is made of a thermoplastic material, such as polycarbonate, polyvinyl chloride, polymethyl methacrylate, or any of their combinations.

In one embodiment, the metal layer is made of gold, silver, aluminum, or any of their combinations.

The present disclosure also discloses a spectrometer, which includes an incident unit, a curved diffraction grating as mentioned above, and a sensing unit. The incident unit has an incident slit for receiving an optical signal (a to-be-detected light). The curved surface of the curved diffraction grating collects the to-be-detected light, and the diffraction structures diffracts the to-be-detected light into a plurality of spectral components. The curved surface can also focuses the diffraction light to the sensing unit. Due to the configuration of the blazed structures, the first order diffraction light can have high diffraction efficiency.

In one embodiment, the sensing unit is a charge coupled device or a CMOS semiconductor.

In one embodiment, the incident unit further includes one or more fibers.

The present disclosure further discloses a manufacturing method of a curved diffraction grating, which includes the following steps of: placing a substrate and a first mold in a pressure chamber, wherein the substrate has a first surface and a second surface, and the second surface is disposed corresponding to the first mold; heating the first mold and injecting a gas into the pressure chamber to form a plurality of microstructures on the second surface, each of the microstructures is a saw-tooth structure and has a first groove surface and a second groove surface, and an included angle between a normal line of the second surface and a normal line of the second groove surface of at least a part of the microstructures is substantially equal to a blazed angle of the curved diffraction grating; placing the substrate and a second mold in the pressure chamber, wherein the second mold has a concave surface, the concave surface is a two-dimensional curved plate structure, and the first surface is disposed opposite to the concave surface; heating the second mold and injecting a gas into the pressure chamber to shape the substrate into a two-dimensional curved plate structure, wherein the second surface configured with the microstructures is a concave surface; and depositing a metal layer on the second surface of the substrate, wherein the metal layer has a plurality of diffraction structures corresponding to the microstructures.

In one embodiment, the heating temperature is 100° C.˜300° C.

In one embodiment, the pressure of the injected gas is 1˜10 kg/cm².

In one embodiment, the manufacturing method further includes a step of: cutting the substrate before the step of depositing the metal layer.

As mentioned above, the curved diffraction grating and the spectrometer of the disclosure have a two-dimensional curved substrate for providing the collimation and focus functions. Besides, the metal layer of the curved diffraction grating has a plurality of diffraction structures corresponding to the microstructures of the substrate. The diffraction structures have substantially blazed angles, so that the first order diffraction light can have high diffraction efficiency. The curved diffraction grating integrates the curved mirror and grating, so the size of the spectrometer can be sufficiently minimized, and the additional optical collimation is not needed. The manufacturing method of the curved diffraction grating of the disclosure utilizes doubly thermal-embossing processes cooperating with the gas pressure method for replacing the expensive and complicated chemical manufacturing process. Accordingly, the manufacturing method of the curved diffraction grating of the disclosure can easily produce the high-quality two-dimensional curved diffraction grating, and it is time saving, simple and cost-effective.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a conventional spectrometer;

FIG. 2A is a schematic diagram showing a curved diffraction grating according to an embodiment of the disclosure;

FIG. 2B is a sectional view of the curved diffraction grating of FIG. 2A along the line A-A;

FIG. 2C is an enlarge view of a part P of the curved diffraction grating shown in FIG. 2B;

FIG. 3 is a schematic diagram showing a spectrometer according to an embodiment of the disclosure;

FIG. 4 is a flow chart of a manufacturing method of a curved diffraction grating according to an embodiment of the disclosure;

FIGS. 5A to 5F are schematic diagrams showing the curved diffraction grating produced by the manufacturing method of FIG. 4;

FIG. 6 is a schematic diagram showing the experimental data of an experimental example after the laser beams of different wavelengths are diffracted by the curved diffraction grating;

FIG. 7 is a schematic diagram showing the experimental data of another experimental example showing the cross-sectional intensity distributions of different wavelengths; and

FIG. 8 is a schematic diagram showing the experimental data of the spectrometer of another experimental example.

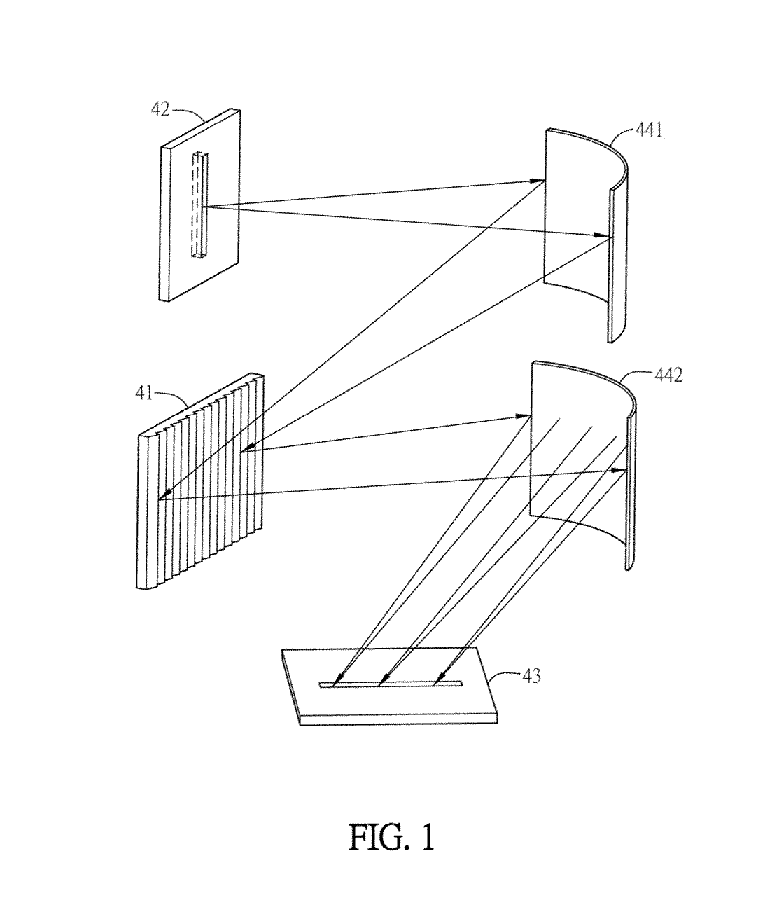

### DETAILED DESCRIPTION OF THE INVENTION

The present invention will be apparent from the following detailed description, which proceeds with reference to the accompanying drawings, wherein the same references relate to the same elements.

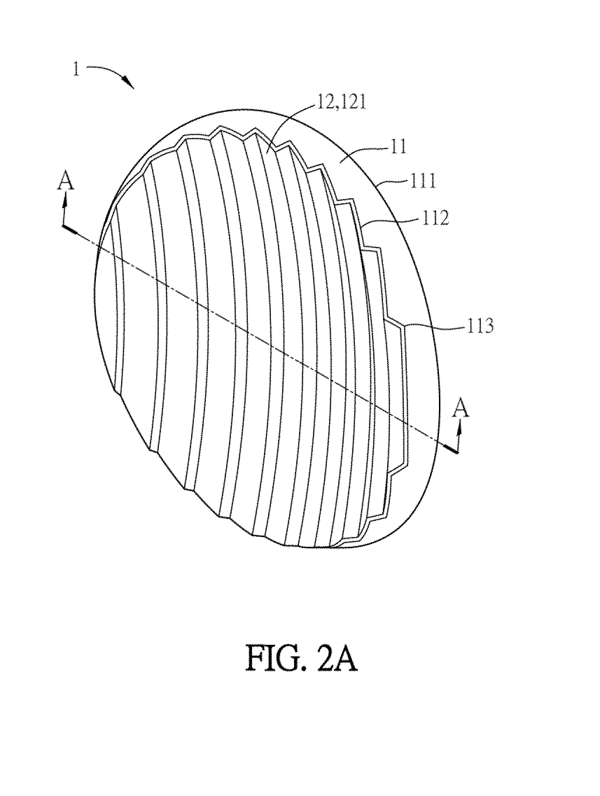

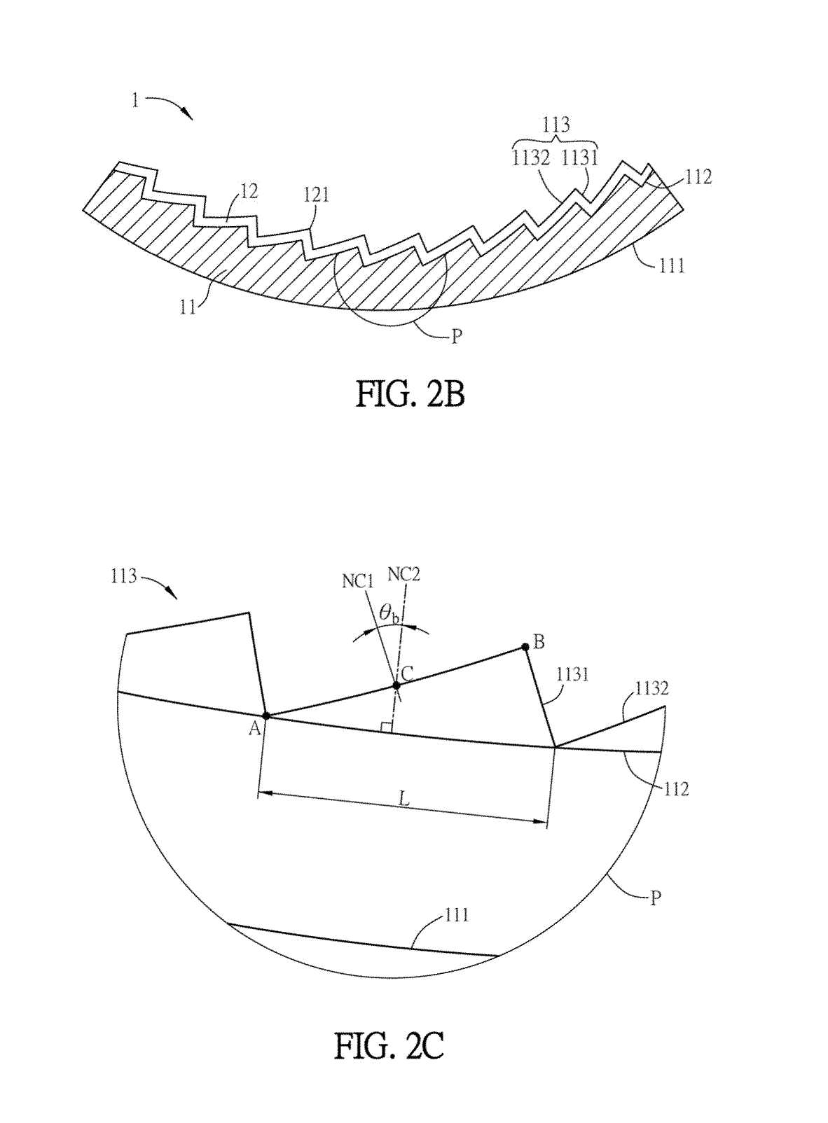

FIG. 2A is a schematic diagram showing a curved diffraction grating according to an embodiment of the disclosure, FIG. 2B is a sectional view of the curved diffraction grating of FIG. 2A along the line A-A, and FIG. 2C is an enlarge view of a part P of the curved diffraction grating shown in FIG. 2B.

Referring to FIGS. 2A, 2B and 2C, the curved diffraction grating 1 includes a substrate 11 and a metal layer 12. The substrate is a two-dimensional curved plate structure and has a first surface 111, a second surface 112, and a plurality of microstructures 113. The first surface 111 is disposed opposite to the second surface 112, and the microstructures 113 are disposed on the second surface 112. Each of the microstructures 113 is a saw-tooth structure and has a first groove surface 1131 and a second groove surface 1132. An included angle between a normal line of the second surface 112 and a normal line of the second groove surface 1132 of at least a part of the microstructures 113 is substantially equal to a blazed angle of the curved diffraction grating 1. The metal layer 12 is disposed on the microstructures 113 and has a plurality of diffraction structures 121 corresponding to the microstructures 113. The diffraction structures 121 are substantially equal to the microstructures 113. In this embodiment, the diffraction structures have high uniformity, and the diffraction wavelengths of the diffraction structures are between 300 nm and 2000 nm. Herein, the uniformity of the diffraction structures is defined as the similarity of all of the diffraction structures on the curved diffraction grating computing with a reference, which assumes that the diffraction structure is substantially a blazed angle.

As mentioned above, at least a part of the diffraction structures 121 are substantially blazed angles. To make the drawings more clear, the microstructures 113 of the substrate 11 replace the diffraction structures 121 in the following description. In this embodiment, as shown in FIG. 2C, the groove density of the microstructures 113 and the diffraction structures 121 is 200˜20000 lines/cm. The width L of the microstructure 113 on the second surface 112 is about several micrometers. Under microscopic view, the second surface 112 of the substrate 11 can be a linear line. A normal line NC2 of the second surface 112 and a normal line NC1 of a point C of the second groove surface 1132 have an included angle θ_{b}. In this condition, the microstructure is substantially a blazed angle θ_{b}. Accordingly, the diffraction structure of the curved diffraction grating is also a blazed angle. The point C of the second groove surface 1132 can be any point on the second groove surface 1132 such as the end point A or B of the second groove surface 1132.

In this embodiment, the substrate 11 can be made of a thermoplastic material, such as polycarbonate, polyvinyl chloride, polymethyl methacrylate, or any of their combinations. The metal layer 12 can be made of gold, silver, aluminum, or any of their combinations.

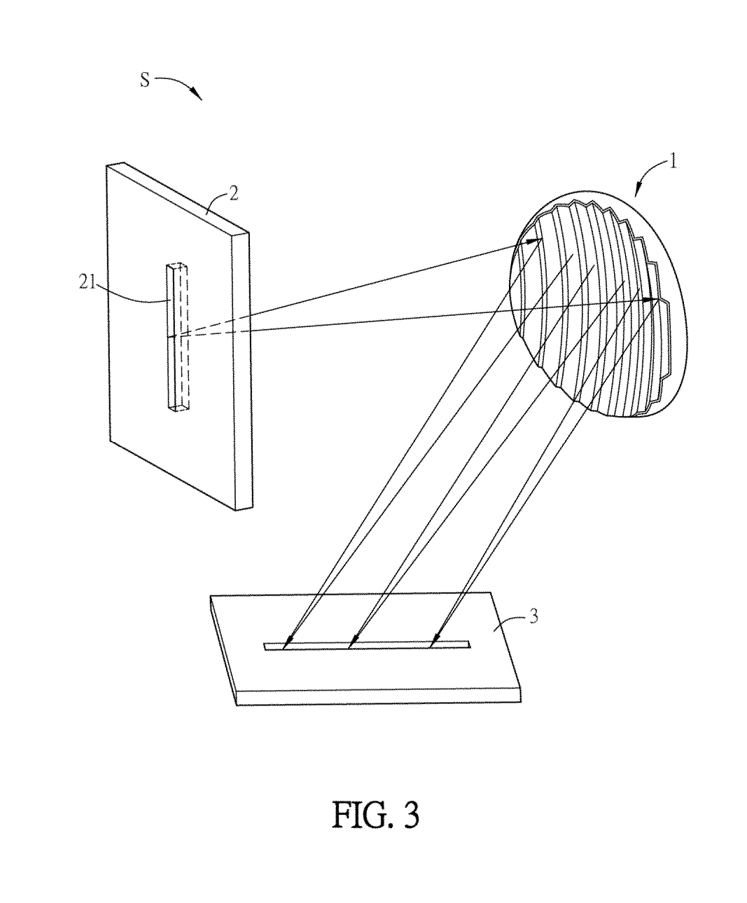

As shown in FIG. 3, a spectrometer S of the disclosure includes an incident unit 2, a curved diffraction grating 1 as mentioned above, and a sensing unit 3. The incident unit 2 has an incident slit 21 for receiving an optical signal. The second surface 112 of the curved diffraction grating 1 focuses the optical signal, and the diffraction structures 121 diffracts the optical signal into a plurality of spectral components. The sensing unit 3 receives the spectral components. Herein, the sensing unit 3 is a charge coupled device or a CMOS semiconductor.

In this embodiment, the incident unit 2 can also be a fiber or a plurality of fibers arranged linearly (not shown). Besides, the functions of the incident unit 2 and the sensing unit 3 can be achieved by a portable electronic device such as a smart phone or a camera.

In this embodiment, the curved diffraction grating has a two-dimensional curved substrate for providing the collimation and focusing functions as a concave mirror. The metal layer has a plurality of diffraction structures corresponding to the microstructures of the substrate, and at least a part of the diffraction structures are substantially blazed angles. Accordingly, the curved diffraction grating of the disclosure can have a high spectral dispersion efficiency and a higher spectral resolution than the normal spec, and the volume of the system can be sufficiently minimized.

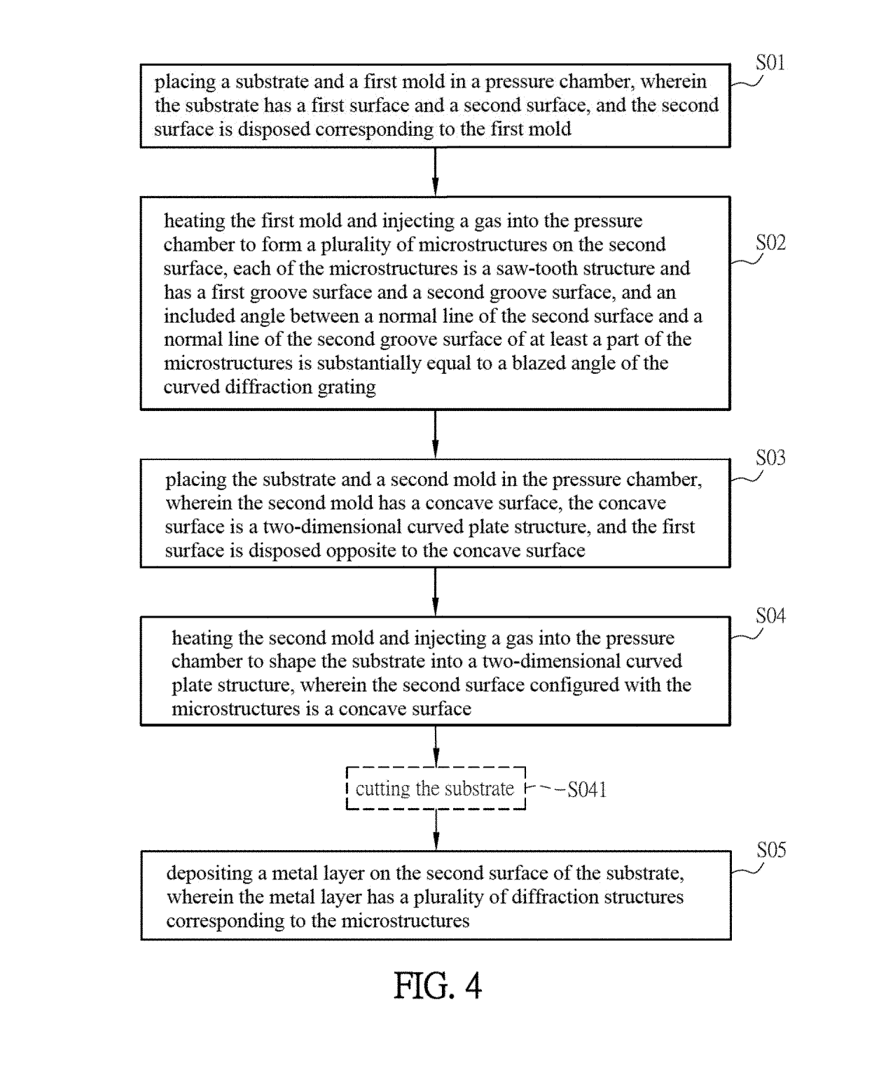

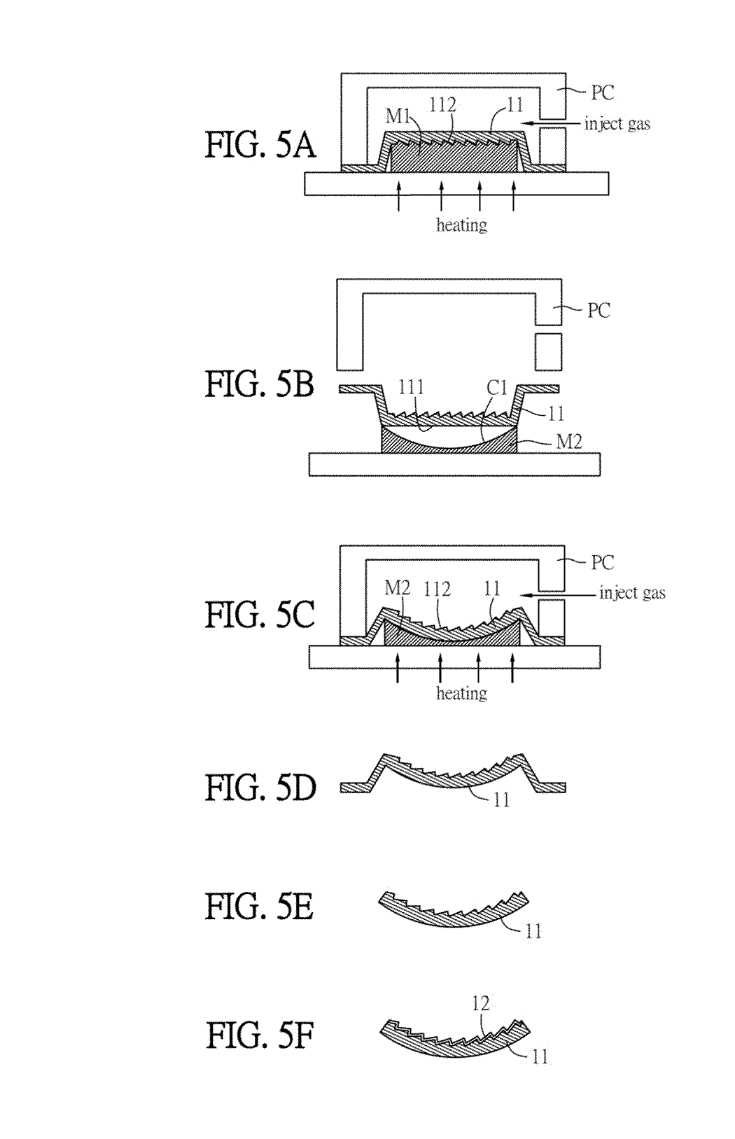

FIG. 4 is a flow chart of a manufacturing method of a curved diffraction grating according to an embodiment of the disclosure, and FIGS. 5A to 5F are schematic diagrams showing the curved diffraction grating produced by the manufacturing method of FIG. 4.

As shown in FIG. 4, the manufacturing method of a curved diffraction grating includes the following steps. In the step S01, a substrate 11 and a first mold M1 are placed in a pressure chamber PC. Herein, the substrate 11 has a first surface 111 and a second surface 112, and the second surface 112 is disposed corresponding to the first mold M1. The first mold M1 has a plurality of grooves, which are substantially blazed structures.

In a step S02, the first mold M1 is heated to or above the glass transition temperature (Tg) of the substrate 11, and a gas is injected into the pressure chamber PC to increase the pressure in the pressure chamber PC, thereby pressing and deforming the second surface 112 of the substrate 11 to form a plurality of microstructures 113. Each of the microstructures 113 is a saw-tooth structure and has a first groove surface 1131 and a second groove surface 1132. An included angle between a normal line of the second surface 112 and a normal line of the second groove surface 1132 of at least a part of the microstructures 113 is substantially equal to an included angle between a tangent line of the second groove surface 1132 and a tangent line of the second surface 112. In this embodiment, at least a part of the microstructures 113 disposed on the second surface 112 are blazed structures.

In the step S03, the substrate 11 is turned over so as to reverse the first surface 111 and the second surface 112 of the substrate 11, and the substrate 11 and a second mold M2 are placed in the pressure chamber PC. Herein, the second mold M2 is a concave mirror or a concave lens. The second mold M2 has a concave surface C1, which is a two-dimensional curved plate structure, and the first surface 111 is disposed opposite to the concave surface C1.

In the step S04, the second mold M2 is heated to or above the glass transition temperature, and a gas is injected into the pressure chamber PC to increase the pressure in the pressure chamber PC, thereby pressing and deforming the substrate 11 into a two-dimensional curved plate structure. Herein, the second surface 112 configured with the microstructures 113 is a concave surface.

In the step S041, the substrate 11 is cut to remove the redundant parts of the fabricated substrate 11.

In the step S05, a metal layer 12 is deposited on the second surface 112 of the substrate 11. Herein, the metal layer 12 has a plurality of diffraction structures 121 corresponding to the microstructures 113, and the diffraction structures 121 are substantially blazed angle structures.

In this embodiment, the heating temperatures of the doubly thermal-embossing processes (steps S02 and S04) are 100° C.˜300° C., and the pressure of the injected gas during the thermal-embossing processes is 1˜10 kg/cm².

The manufacturing method of a curved diffraction grating of this disclosure utilizes doubly thermal-embossing processes cooperating with the gas pressure method for effectively transferring the patterns of the blazed grooves and concave surface of the mold to the second surface of the substrate. This approach can replace the expensive and complicated chemical manufacturing process. Accordingly, the manufacturing method of the curved diffraction grating of the disclosure can easily produce the high-quality two-dimensional curved diffraction grating, and it is time saving, simple and cost-effective.

The properties of the curved diffraction grating fabricated by the above manufacturing method and the spectrometer of the disclosure will be discussed in the following experimental examples.

In the first experimental example, the spectrometer of FIG. 3 is utilized for analyzing. In this example, the focal length of the substrate 11 of the curved diffraction grating 1 is 10.5 cm, and the groove density of the microstructures 113 is 1200 lines/mm. The sensing unit of the spectrometer is a CCD (charge-coupled device) for capturing the diffraction images of white light being reflected from the curved diffraction grating 1. The spectral resolution is then calculated.

The spectral resolution Δλ can be determined by the follow equation:

$$Δλ = \frac{{λ}_{peak 2} - {λ}_{peak 1}}{{P}_{peak 2} - {P}_{peak 1}} \times FWHM$$

Wherein, λₚₑₐₖ₁ and λₚₑₐₖ₂ are the incident laser wavelengths, Pₚₑₐₖ₁ and Pₚₑₐₖ₂ are the maximum peaks of the pixel positions of the CCD images, FWHM is the full width half maximum of focused laser beam profile of the CCD images.

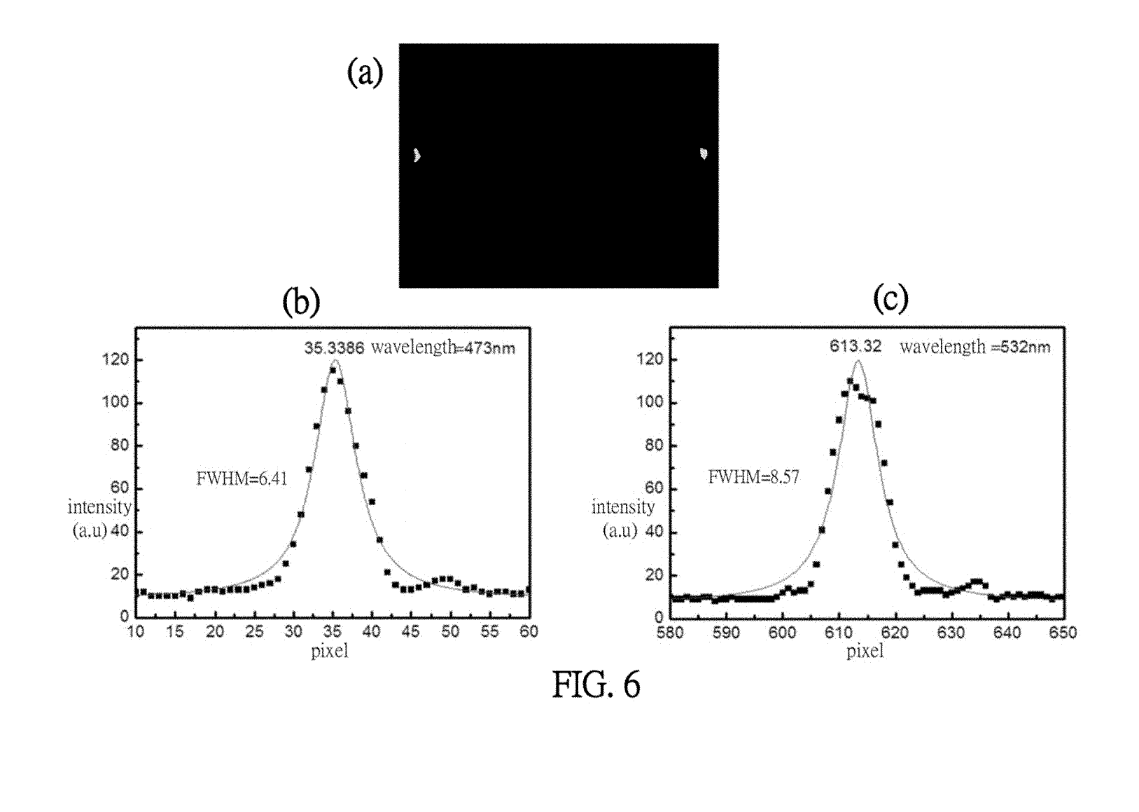

FIG. 6(a) shows a CCD image of focus beam at 473 nm and 532 nm, cross section of CCD image and Lorentzian approximation at 473 nm (FIG. 6(b)) and 532 nm (FIG. 6(c)), respectively. FIGS. 6(b) and 6(c) show the FWHM values of the laser beam and the maximum peaks of the focal laser at 473 nm and 532 nm, respectively. In this example, the spectral resolution of the curved diffraction grating was estimated to be 0.8 nm, which is comparable to commercial spectrometers.

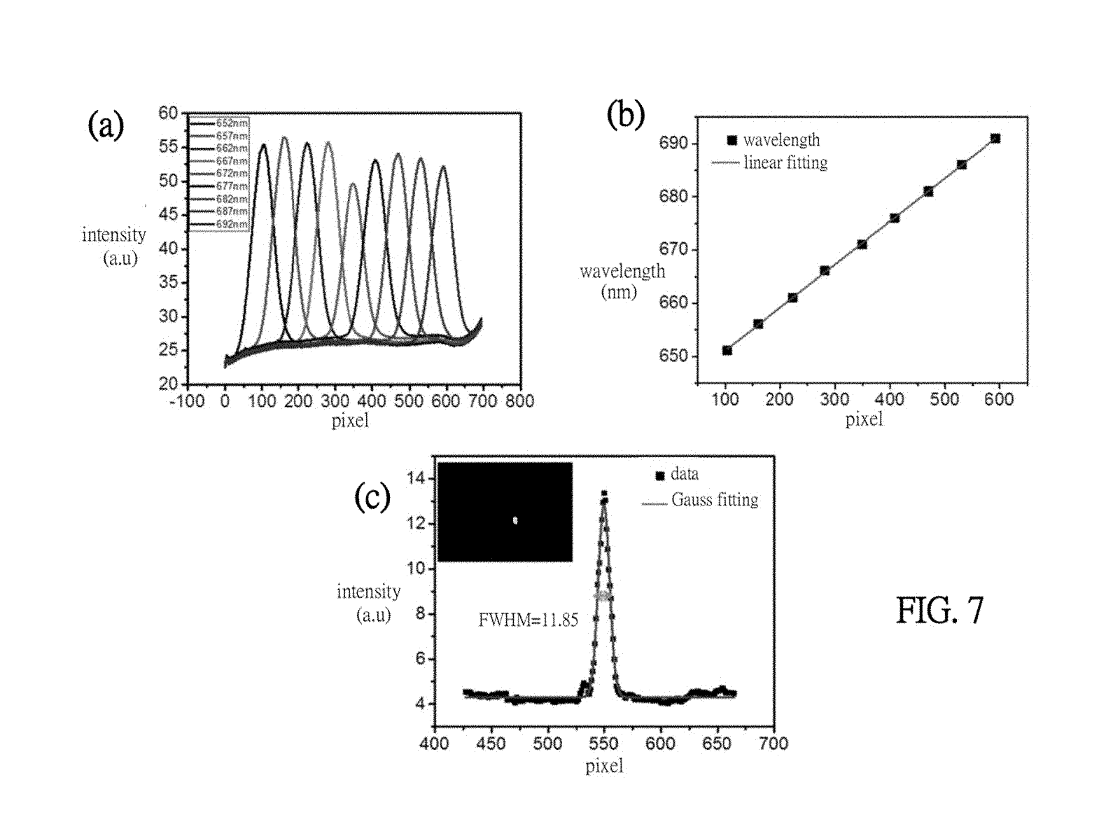

In the second experimental example, as shown in FIGS. 7(a) to 7(c), the spectral resolution of the spectrometer system is estimated by applying white light and red laser beam with different wavelengths. FIG. 7(a) shows the cross-sectional intensity distributions of CCD images, FIG. 7(b) shows the linear fitting of wavelength-to-pixel relation, and FIG. 7(c) shows the spectral resolution estimated from red laser beam at wavelength 632 nm.

In this example, it can further estimate the spectral resolution by using a white light source and a monochromator. As shown in FIG. 7(a), the selected wavelengths are 652 nm, 657 nm, 662 nm, 667 nm, 672 nm, 677 nm, 682 nm, 687 nm and 692 nm. the cross-sectional intensity distributions of the CCD images are shown in FIG. 7(a). From the above equation and FIG. 7(b), the pixel-to-wavelength resolution of this spectrometer system under the wavelength range is estimated to be 0.08 nm/pixel. Then, a red laser beam (632 nm) is used to verify the spectral resolution of the spectrometer system of this example. As shown in FIG. 7(c), the measured FWHM of the red laser beam is 11.85 pixels, which is equal to 0.9 nm when multiplied by 0.08 nm/pixel. As a result, the spectral resolution of this spectrometer system of the disclosure is 0.9 nm.

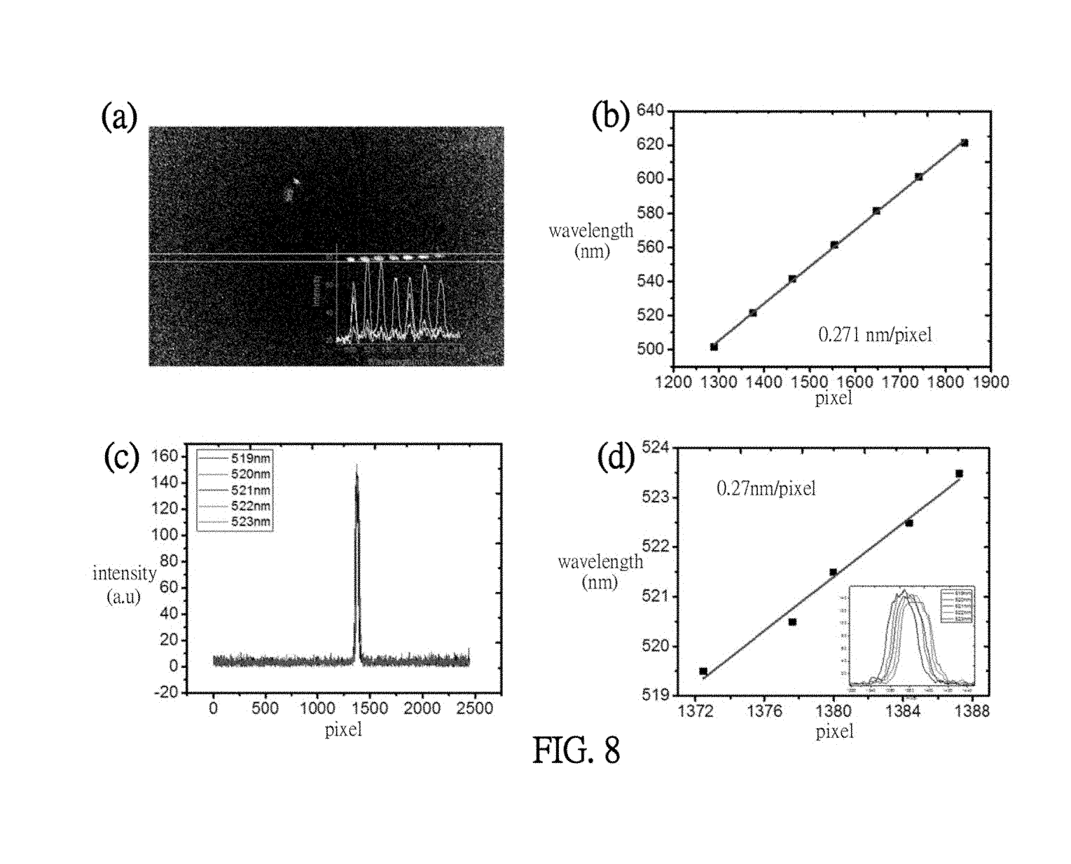

In the third experimental example, the pixel resolution of the spectrometer of this disclosure can be estimated by applying spectra of a 1 nm wavelength interval light source. FIG. 8(a) shows spectral images of wavelengths from 525 nm to 625 nm with 25 nm interval. FIG. 8(b) shows pixel-to-wavelength conversion of FIG. 8(a) and linear fitting for pixel resolution. FIG. 8(c) shows spectra of a 1 nm wavelength interval light source. FIG. 8(d) shows pixel-to-wavelength conversion of FIG. 8(c) and linear fitting for pixel resolution.

In this example, the pixel resolution is estimated with the spectrometer system of this disclosure cooperated with a smartphone or a camera. As shown in FIG. 8(a), the white light source (the wavelengths at 525 nm, 550 nm, 575 nm, 600 nm and 625 nm) is provided to pass through the monochromator. The recorded light spots are shown in FIG. 8(a), and the pixel-to-wavelength conversion with linear fitting is demonstrated in FIG. 8(b). The measuring result indicates the spectral resolution of 0.271 nm/pixel. The detected spectra and the corresponding pixel-to-wavelength linear fitting of another experimental example are shown in FIGS. 8(c) and 8(d). The measuring result indicates the spectral resolution of 0.27 nm/pixel. According to the above measuring results, the spectrometer system of the disclosure has high stability.

As mentioned above, the curved diffraction grating and the spectrometer of the disclosure have a two-dimensional curved substrate for providing the collimation and focus functions as the concave mirror. Besides, the metal layer of the curved diffraction grating has a plurality of diffraction structures corresponding to the microstructures of the substrate. The diffraction structures have substantially blazed angles, so that the curved diffraction grating can have high spectral dispersion efficiency, high spectral resolution and high stability. Accordingly, the volume of the spectrometer of the disclosure can be sufficiently minimized.

In addition, the manufacturing method of the curved diffraction grating of the disclosure utilizes doubly thermal-embossing processes cooperating with the gas pressure method for effectively transferring the blazed grooves and concave surface of the molds to the second surface of the substrate. This approach can replace the expensive and complicated chemical manufacturing process. Accordingly, the manufacturing method of the curved diffraction grating of the disclosure can easily produce the high-quality two-dimensional curved diffraction grating, and it is time saving, simple and cost-effective.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A curved diffraction grating comprising:
a substrate having a first surface, a second surface and a plurality of microstructures, wherein the substrate is a two-dimensional curved plate structure, the first surface is disposed opposite to the second surface, the microstructures are disposed on the second surface, each of the microstructures is a saw-tooth structure and has a first groove surface and a second groove surface, and an included angle between a normal line of the second surface and a normal line of the second groove surface of at least a part of the microstructures is substantially equal to a blazed angle of the curved diffraction grating; and
a metal layer disposed on the microstructures and having a plurality of diffraction structures corresponding to the microstructures.

2. The curved diffraction grating of claim 1, wherein at least a part of the diffraction structures are substantially blazed angles.

3. The curved diffraction grating of claim 1, wherein a diffraction wavelength of the diffraction structure is between 300 nm and 2000 nm.

4. The curved diffraction grating of claim 1, wherein a groove density of the diffraction structures is 200˜20000 lines/cm.

5. The curved diffraction grating of claim 1, wherein the substrate is made of a thermoplastic material, polycarbonate, polyvinyl chloride, polymethyl methacrylate, or any of their combinations.

6. The curved diffraction grating of claim 1, wherein the metal layer is made of gold, silver, aluminum, or any of their combinations.

7. A spectrometer, comprising:
an incident unit having an incident slit for receiving an optical signal;
a curved diffraction grating comprising a substrate and a metal layer, wherein the substrate is a two-dimensional curved plate structure and has a first surface, a second surface and a plurality of microstructures, the first surface is disposed opposite to the second surface, the microstructures are disposed on the second surface, each of the microstructures is a saw-tooth structure and has a first groove surface and a second groove surface, an included angle between a normal line of the second surface and a normal line of the second groove surface of at least a part of the microstructures is substantially equal to a blazed angle of the curved diffraction grating, the metal layer is disposed on the microstructures and has a plurality of diffraction structures corresponding to the microstructures, the second surface focuses the optical signal, and the diffraction structures diffracts the optical signal into a plurality of spectral components; and
a sensing unit for receiving the spectral components.

8. The spectrometer of claim 7, wherein the sensing unit is a charge coupled device or a CMOS semiconductor.

9. The spectrometer of claim 7, wherein the incident unit further comprises one or more fibers.

10. The spectrometer of claim 7, wherein at least a part of the diffraction structures are substantially blazed structures.

11. The spectrometer of claim 7, wherein a diffraction wavelength of the diffraction structure is between 300 nm and 2000 nm.

12. The spectrometer of claim 7, wherein a groove density of the diffraction structures is 200˜20000 lines/cm.

13. The spectrometer of claim 7, wherein the substrate is made of a thermoplastic material, polycarbonate, polyvinyl chloride, polymethyl methacrylate, or any of their combinations.

14. The spectrometer of claim 7, wherein the metal layer is made of gold, silver, aluminum, or any of their combinations.

15. A manufacturing method of a curved diffraction grating, comprising following steps of:
placing a substrate and a first mold in a pressure chamber, wherein the substrate has a first surface and a second surface, and the second surface is disposed corresponding to the first mold;
heating the first mold and injecting a gas into the pressure chamber to form a plurality of microstructures on the second surface, each of the microstructures is a saw-tooth structure and has a first groove surface and a second groove surface, and an included angle between a normal line of the second surface and a normal line of the second groove surface of at least a part of the microstructures is substantially equal to a blazed angle of the curved diffraction grating;
placing the substrate and a second mold in the pressure chamber, wherein the second mold has a concave surface, the concave surface is a two-dimensional curved plate structure, and the first surface is disposed opposite to the concave surface;
heating the second mold and injecting a gas into the pressure chamber to shape the substrate into a two-dimensional curved plate structure, wherein the second surface configured with the microstructures is a concave surface; and
depositing a metal layer on the second surface of the substrate, wherein the metal layer has a plurality of diffraction structures corresponding to the microstructures.

16. The manufacturing method of claim 15, wherein the heating temperature is 100° C.˜300° C.

17. The manufacturing method of claim 15, wherein a pressure of the injected gas is 1˜10 kg/cm2.

18. The manufacturing method of claim 15, further comprising a step of:
cutting the substrate before the step of depositing the metal layer.
